(19) United States
(12) Patent Application Publication
(10) Pub. No.: US 2025/0051244 A1
(43) Pub. Date: Feb. 13, 2025

(54) COMPOSITIONS AND METHODS FOR REDUCING AGRICULTURAL INPUTS

(71) Applicant: POET Research, Inc., Sioux Falls, SD (US)

(72) Inventors: Paul Seward, Nairobi (KE); Jason Martin, Emmetsburg, IA (US); Andy Vickers, Sioux Falls, SD (US); David Priest, Nairobi (KE); Brett A. Flittie, Harrisburg, SD (US); Andrew J. Manning, Sioux Falls, SD (US); Tapaswy Muppaneni, Sioux Falls, SD (US)

(21) Appl. No.: 18/799,153

(22) Filed: Aug. 9, 2024

Related U.S. Application Data
(60) Provisional application No. 63/531,991, filed on Aug. 10, 2023.
(60) Provisional application No. 63/604,717, filed on Nov. 30, 2023.

(51) Int. Cl. C05D 9/00; C05D 3/00; C05F 11/00; C05G 3/20; C05G 5/12

(52) U.S. Cl. CPC C05D 9/00; C05D 3/00; C05F 11/00; C05G 3/20; C05G 5/12

(57) ABSTRACT

Soil additives that include at least a diatomaceous earth ingredient, a calcium sulfate ingredient, and a biochar ingredient. Soil additives that include at least a diatomaceous earth ingredient, a calcium sulfate ingredient, and a limestone ingredient. Related methods of making and using such soil additives for growing crops.

### CROSS-REFERENCE TO RELATED APPLICATION

This nonprovisional patent application claims the benefit of U.S. Provisional Patent Application Ser. No. 63/531,991, filed on Aug. 10, 2023, and U.S. Provisional Patent Application Ser. No. 63/604,717, filed on Nov. 30, 2023, wherein each of said provisional patent applications is incorporated herein by reference in its entirety.

### BACKGROUND

Modern agriculture utilizes various inputs, including e.g., synthetic inputs, to enhance crop health and yields. In particular, large amounts of nitrogen fertilizer and pesticides are produced and applied to crops worldwide at great cost and with environmental impact. There is a continuing need to reduce the use of such synthetic inputs to reduce greenhouse gas emissions and lower farming costs while preserving crop health and yield.

### SUMMARY

The present disclosure relates to compositions and methods that reduce agricultural inputs, e.g., nitrogen inputs, synthetic inputs such as fertilizer, e.g., synthetic nitrogen fertilizer, and/or pesticides.

The present disclosure includes embodiments of soil additive that includes at least a diatomaceous earth ingredient; a calcium sulfate ingredient; and a biochar ingredient.

The present disclosure also includes embodiments of a method of making a soil additive. The method includes mixing at least a diatomaceous earth ingredient; a calcium sulfate ingredient; and a biochar ingredient to form a mixture.

The present disclosure also includes embodiments of a method of using a soil additive according to the present disclosure. The method includes applying the soil additive to soil that is intended to grow crop seeds and/or other planting material.

The present disclosure also includes embodiments of a method of growing a plant. The method includes growing a crop in soil treated with a soil additive according to the present disclosure and at least fifty percent less of synthetic nitrogen fertilizer as compared to a control crop grown with one hundred percent of the synthetic nitrogen fertilizer and without the soil additive. The crop produces a yield of 100% or greater of a yield produced by the control crop.

The present disclosure also includes embodiments of a method of remediating biotic stress of a plant caused by one or more organisms. The method includes growing a crop in soil treated with a soil additive according to the present disclosure. The plant has a lower biotic stress as compared to a control plant grown in soil without the soil additive.

The present disclosure includes embodiments of soil additive that includes at least a diatomaceous earth ingredient; a calcium sulfate ingredient; and a limestone ingredient.

### BRIEF DESCRIPTION OF THE DRAWINGS

Various examples of the present disclosure will be discussed with reference to the appended drawings. These drawings depict only illustrative examples of the disclosure and are not to be considered limiting of its scope.

FIG. 1 is a schematic diagram of the test plot layout of Example 1;

FIG. 2 is a bar chart depicting the results of Example 1;

FIG. 3 is a photograph of pellets formed in Example 5;

FIG. 4 is a photograph of a mixture used to form pellets in Example 6;

FIG. 5 is a photograph of pellets formed in Example 6;

FIG. 6 is a photograph of an agglomerated blend after cement mixer (left) and granules after granulation (right) as described in Example 11;

FIG. 7 is a photograph of granules of different sizes after drying as described in Example 11;

FIG. 8 is bar chart depicting biomass production of Example 12;

FIG. 9 is bar chart depicting nutrient consumption per gram of biomass of Example 12;

FIG. 10 is bar chart depicting plant height across all treatments using a half rate of fertilizer of Example 12;

FIG. 11 is bar chart depicting plant height across all treatments using a full rate of fertilizer of Example 12;

FIG. 12 is bar chart depicting plant weight across all treatments using a half rate of fertilizer of Example 12;

FIG. 13 is bar chart depicting plant weight across all treatments using a full rate of fertilizer of Example 12;

FIG. 14 is oats biomass production from Example 13;

FIG. 15 is a photograph of a pan granulator used in Example 11;

FIG. 16A shows a process-flow diagram of a non-limiting embodiment of a dry-grind corn ethanol bioprocessing facility configured to form a plurality of stillage compositions;

FIG. 16B shows a process-flow diagram of a non-limiting embodiment of the corn oil separation system shown in FIG. 16A;

FIG. 17A is bar chart depicting plant-parasitic nematodes on coffee plant roots among farms F1 to F11 of Example 14; and

FIG. 17B is bar chart depicting average plant-parasitic nematodes on coffee plant roots of Example 14.

### DETAILED DESCRIPTION

The present disclosure relates to compositions and methods that reduce the amount of agricultural inputs applied to soil for growing plants, e.g., synthetic inputs such as fertilizer and/or pesticides. As used herein, a “plant” refers to any plant such as grasses, grains, legumes, trees (woody plants), shrubs, mosses, ferns, algae, aquatic plants (e.g., sea weeds), cyanobacteria, and the like. A plant can be grown in nurseries, pots, fields (e.g., as crops), etc., and may be grown at a permanent site (e.g., a field) or a temporary site (e.g., in pots).

A soil additive according to the present disclosure can be applied to a wide variety of soils for growing a wide variety of crops. Crops are plants, or products made from plants, that are grown and harvested for subsistence and/or profit. Non-limiting examples of such crops include food crops, feed crops, fiber crops, oil crops, ornamental crops, and/or industrial crops. Food crops include one or more of fruits (e.g., mango, coffee, etc.), berries, vegetables (e.g., leafy vegetables, avocado, and the like), grains (e.g., wheat, rice, corn, etc.), tubers (e.g., potatoes, etc.), and the like. Feed crops are grown and harvested to feed livestock, and include grains (corn, oats, etc.), alfalfa, grasses, hay, and the like. Fiber crops can be processed into textiles and include cotton, flax, hemp, etc. Oil crops can be grown for human consumption and/or industrial uses and include one or more of corn, sunflower, olives, etc. Ornamental crops include plants and trees for landscaping. Industrial crops include crops that are not consumed but use in manufacturing processes such as rubber.

According to one aspect of the present disclosure, a soil additive is formulated to reduce the amount of synthetic fertilizer and/or pesticides that are applied to the soil. Advantageously, a soil additive according to the present disclosure can facilitate producing one or more of similar crop yields (e.g., in terms of crop biomass produced (e.g., pounds per bushel of grain produced)), nutrient (e.g., nitrogen) utilization efficiency, combinations of these, and the like, with less than one hundred percent of the recommended synthetic nitrogen fertilizer application rate as compared to a crop grown with one hundred percent of the recommended synthetic nitrogen fertilizer application rate and without the soil additive.

According to one aspect of the present disclosure, a soil additive is formulated to provide robust performance in terms of biomass production when a crop is exposed to stressed environmental conditions such as drought.

In some embodiments, a soil additive includes a combination of ingredients including at least a diatomaceous earth ingredient, a calcium sulfate ingredient, and a biochar ingredient. In some embodiments, a soil additive can include one or more additional components or ingredients.

As used herein, an ingredient refers to a chemical compound (e.g., calcium sulfate ingredient) or composition (e.g., diatomaceous earth ingredient and/or biochar ingredient) that can have various levels of purity. For example, gypsum is considered to be a calcium sulfate ingredient. In some embodiments, gypsum can include one or more forms of calcium sulfate ingredient such as calcium sulfate ingredient dihydrate (CaSO4·2H2O), calcium sulfate ingredient anhydrite, hemihydrate, and combinations thereof. Gypsum may also include other components such as sulfur.

As used herein, a “soil additive” can be present in any desirable physical form. Non-limiting examples of physical forms of a soil additive include a free-flowing powder (e.g., a powder of the same composition or a mixture of multiple powders of different compositions), an agglomeration of a free-flowing powder and one or more binders, and/or one or more discrete units formed in an additive manner from free-flowing powder such as granules (discussed below). As mentioned above, a soil additive according to the present disclosure can include at least a diatomaceous earth ingredient, a calcium sulfate ingredient, and a biochar ingredient. Optionally, a soil additive according to the present disclosure can include one or more additional components or ingredients, which are discussed below. In some embodiments, calcium carbonate can be included in a soil additive.

A diatomaceous earth ingredient (DE) is a naturally occurring sedimentary rock made up of the fossilized remains of ancient hard-shelled algae called diatoms. DE occurs in formations that can be mined and ground. DE deposits differ in their composition and use.

For example, DE deposits of saltwater diatoms contain a high content of crystalline silica and are useful for filtration. DE deposits of freshwater diatoms contains a low content of crystalline silica and are useful in food grade applications such as pest control and in food and feed uses. According to the present disclosure, DE may improve soil porosity, supply silicon, buffer soil acidity, improve nutrient availability, retain nutrients, serve as a carrier for other components, and/or aid in pest control. For example, the silica content of DE may help plant cells be more resistant to diseases and biotic stress caused by pests (discussed below). In some embodiments, the diatomaceous earth ingredient according to the present disclosure includes a silicon dioxide content of at least 80 percent by total weight of the diatomaceous earth ingredient. In some embodiments, the diatomaceous earth ingredient according to the present disclosure includes a silicon dioxide content from 80 percent to 99.9 percent, or even from 85 percent to 99 percent by total weight of the diatomaceous earth ingredient. In some embodiments, the diatomaceous earth ingredient according to the present disclosure has a pH in a range from 6.5 to 12, or even from 7.5 to 11.5.

In some embodiments, a soil additive can be formed from diatomaceous earth ingredient powder.

In some embodiments, DE may be milled or ground to a fine powder. Commercially DE can be provided as a fine powder. The particle size distribution of the diatomaceous earth ingredient powder may be determined by sieve analysis. In this procedure, screens of different mesh size are stacked such that the screen openings are successively smaller from top to bottom. A diatomaceous earth ingredient powder sample is placed on the top screen and the stack is tapped or shaken for a defined period of time (e.g., 10 minutes). This tapping moves the sample around the first screen and the material that is smaller than the sieve size falls through the first screen to the next screen. This continues until the original sample has been separated into its various sieve size fractions. The results may be expressed as the percent by weight of diatomaceous earth ingredient powder that is retained on a screen having a certain mesh size. Alternatively, the results may be expressed as the percent by weight of diatomaceous earth ingredient powder that passes through a screen having a certain mesh size. Mesh size refers to the mesh number, which is a US measurement standard, and its relationship to the size of the openings in the mesh and therefore the size of diatomaceous earth ingredient powder particles that pass through the mesh openings. The “mesh number” refers the number of openings in one linear inch of sieve screen. For example, a 100-mesh screen has 100 openings per inch, etc. As the number indicating the mesh size increases, the size of the openings and thus the size of diatomaceous earth ingredient powder captured by the screen decreases. That is, higher mesh numbers correspond to smaller particle sizes.

In some embodiments, diatomaceous earth ingredient powder has a particle size distribution such that at least 90%, 95%, or even 100% by weight of the particles pass through an 18 mesh screen (1000 microns); at least 90%, 95%, or even 100% by weight of the particles pass through a 35 mesh screen (500 microns); from 80-95%, or even from 85-95% by weight of the particles pass through a 60 mesh screen (250 microns); from 60-80%, or even from 65-75% by weight of the particles pass through a 140 mesh screen (105 microns); and/or from 50-70%, or even from 55-70% by weight of the particles pass through a 270 mesh screen (53 microns). DE powder can be relatively light and fluffy, which can make it relatively challenging to handle. For example, DE powder can be challenging to handle as a raw material, for example, while combining with one or more other ingredients, mixing with one or more other ingredients, and/or one or more of packaging, transporting, and storing as a product in powder form. DE powder can also be challenging to apply to soil because DE powder can be easily dispersed by wind. As discussed below, DE powder can be formulated with other components into a physical form that is relatively easier to handle and apply to soil in a more efficient manner. In some embodiments, although DE powder can be relatively challenging to handle and/or apply to soil because DE powder is relatively light and fluffy, the same DE powder can facilitate making discrete units such as granules, pellets, prills, and/or extrusions, that are robust and easier to handle as long as the DE powder can mix well with other ingredients to form the discrete units.

A DE component can include calcined DE and/or uncalcined DE. Calcined DE is formed via calcination. Calcination is a thermal treatment of a solid chemical compound that involves heating the compound to high temperature without melting under restricted supply of oxygen for the purpose of removing impurities and/or volatile substances and/or to cause thermal decomposition.

Calcium sulfate ingredient (or calcium sulfate ingredient) is an inorganic compound of calcium. sulfur, and oxygen, with the formula CaSO4 and related hydrates. Calcium sulfate ingredient can occur naturally (natural gypsum) or produced as a by-product of a number of processes (synthetic gypsum). It can occur naturally in the form of calcium sulfate ingredient dihydrate also known as gypsum. Gypsum can be mined and has many uses including as a fertilizer. In some embodiments, gypsum may be selected because it can reduce nitrogen volatilization in at least some soils. In the present disclosure, gypsum may improve soil productivity by providing calcium and sulfur and displacing sodium. Further, gypsum may supply sulfur, which may otherwise be limited in in many soils for growing crops.

According to the present disclosure, “calcium sulfate ingredient” tends to be a relatively pure ingredient. In some embodiments, calcium sulfate ingredient can include at least 65%, at least 70%, at least 75%, at least 80%, at least 85%, at least 90%, or even at least 95% by weight of calcium sulfate ingredient based on the total weight of the calcium sulfate ingredient. In some embodiments, a calcium sulfate ingredient according to the present disclosure can include a calcium sulfate ingredient dihydrate content of at least 95 percent by total weight of the calcium sulfate ingredient on a dry weight basis. Calcium sulfate ingredient can include one or more additional components. For example, in some embodiments, calcium sulfate ingredient can include calcium oxide (CaO) in an amount of 30% or less, 20% or less, or even 10% or less by weight based on the total weight of the calcium sulfate ingredient. As another example, as Tables 4a and 4b below show, the calcium sulfate ingredient gypsum can include relatively lower amounts of one or more components. In some embodiments, sulfur can be present in an amount of 15% or less, 10% or less, or even 5% or less by weight based on the total amount of the calcium sulfate ingredient. Also, for particulate forms such as powder, calcium sulfate ingredient tends to be a relatively dry ingredient (low in moisture content). In some embodiments, the calcium sulfate ingredient has a moisture content of 10% or less, 8% or less, 5% or less, 2% or less, or even 1% or less by weight based on the total weight of the calcium sulfate ingredient. In some embodiments, the calcium sulfate ingredient has a moisture content in a range from 0.1 to 10, or even 0.1 to 5 percent by total weight of the calcium sulfate ingredient.

The calcium sulfate ingredient can be a powder that is combined with one or more other ingredients to form a soil additive according to present disclosure. In some embodiments, calcium sulfate ingredient such as gypsum may be milled or ground to a fine powder. Commercially, calcium sulfate ingredient can be provided as a fine powder. Smaller particle sizes appear to be of greater benefit in agriculture. In some embodiments, calcium sulfate ingredient powder has a particle size distribution such that at least 90%, 95%, or even 100% by weight of the particles pass through an 18 mesh screen (1000 microns); at least 90%, 95%, or even 100% by weight of the particles pass through a 35 mesh screen (500 microns); from 80-95%, or even from 85-95% by weight of the particles pass through a 60 mesh screen (250 microns); from 60-80%, or even from 65-75% by weight of the particles pass through a 140 mesh screen (105 microns); and/or from 50-70%, or even from 55-70% by weight of the particles pass through a 270 mesh screen (53 microns).

A calcium sulfate ingredient (e.g., gypsum powder) can include calcined calcium sulfate ingredient and/or uncalcined calcium sulfate ingredient.

Biochar ingredient is the solid residue produced by thermal decomposition of biomass in the absence of oxygen or presence of limited oxygen. It has a porous, micro structure. It is formed by heating biomass in a low oxygen environment. Biochar ingredient can have a wide variety of chemical and/or physical properties that can depend on one or more of the plant species the biochar ingredient is derived from and/or the temperature at which biochar ingredient is produced at. The primary component of biochar ingredient is recalcitrant carbon, which can persist in soils for years, decades, or even millennia. As shown in Tables 4a and 4b of Example 9 below, biochar ingredient can include trace amounts of one or more components. Biochar ingredient can have a range of pH that can also depend on one or more of the plant species the biochar ingredient is derived from and the temperature at which biochar ingredient is produced at. The pH of biochar ingredient tends to increase as the biochar ingredient production temperature increases. In some embodiments, a biochar ingredient according to the present disclosure has a pH in a range from 4.5 to 9.5, or even 5 to 9.

In the present disclosure, biochar ingredient may improve soil properties for agriculture by one or more of improving soil structure, buffering pH, retaining nutrients, providing a porous carrier for other components, and providing a medium for in-situ growth of beneficial microorganisms. In addition, biochar ingredient provides a mechanism for sequestering atmospheric carbon absorbed by plants. A variety of sources of biomass can be used to form biochar ingredient. Non-limiting examples of biomass include wood, wood waste (e.g., sawdust), agricultural or crop residues. Non-limiting examples of crop residues include residues (stems, stalks, husks, leaves, and/or cobs) of corn, beans, sorghum, wheat, rice, oats, barley, sugarcane, other crops, and combinations thereof. In many areas, wood and wood waste are not readily available at low cost but crop residues including, e.g., stems, leaves and cobs are. Further, crop residues may also produce biochar ingredient with greater improved porosity (greater pore space).

The biochar ingredient can be present in a soil additive as biochar ingredient powder. In some embodiments, biochar ingredient may be milled or ground into particles. Biochar ingredient having relatively small particle sizes can be of greater benefit in agriculture. In some embodiments, biochar ingredient powder has a particle size distribution such that at least 90%, 95%, or even 100% by weight of the particles pass through an 18 mesh screen (1000 microns); at least 90%, 95%, or even 100% by weight of the particles pass through a 35 mesh screen (500 microns); from 80-95%, or even from 85-95% by weight of the particles pass through a 60 mesh screen (250 microns); from 60-80%, or even from 65-75% by weight of the particles pass through a 140 mesh screen (105 microns); and/or from 50-70%, or even from 55-70% by weight of the particles pass through a 270 mesh screen (53 microns).

In some embodiments, biochar ingredient can be prepared by contacting biochar ingredient with a nutrient composition in liquid form under conditions that at least a portion of the nutrients from the nutrient composition become incorporated on and/or within the biochar ingredient. As one example, while still hot from production of the biochar ingredient, the biochar ingredient can be submerged in, doused with, and/or sprayed with a liquid, nutrient composition. While not being bound by theory, it is believed that contacting hot biochar ingredient with a liquid, nutrient composition in such a manner can more effectively bind the nutrients from the liquid onto and/or into the biochar ingredient so that the nutrients are available after the biochar ingredient has been formed into a soil additive according to the present disclosure. A non-limiting example of a liquid nutrient composition includes one or more stillage compositions (discussed below), for example, from a corn grain ethanol bioprocessing facility. A non-limiting example of a liquid nutrient composition includes urine waste from animals and/or humans.

In some embodiments, a soil additive includes a combination of ingredients including at least a diatomaceous earth ingredient, a calcium sulfate ingredient, and a limestone ingredient. In some embodiments, the diatomaceous earth ingredient is present in the soil additive in an amount from 25-50% dry weight basis (dwb), wherein the calcium sulfate ingredient is present in the soil additive in an amount from 25-50% dwb, and the limestone ingredient is present in the soil additive in an amount from 25-50% dwb.

A limestone ingredient can include dolomitic limestone ingredient, calcitic limestone ingredient, and combinations thereof. Dolomitic limestone ingredient (or dolomitic limestone), is a combination of calcium carbonate and magnesium carbonate. Having magnesium present can be advantageous where its presence is otherwise limited. Dolomitic limestone helps neutralize acids in the growing medium (e.g., soil) and provides some additional magnesium and calcium for plant uptake. Dolomitic limestone dissolves relatively slowly in the growing medium, resulting in longer-term pH adjustment and buffering to improve pH stability. The particle size of dolomitic limestone can impact how quickly it will dissolve after being applied to soil and exposed to moisture. Relatively coarser dolomitic limestone can take longer to dissolve and impact the pH of soil.

Calcitic limestone is calcium carbonate, with little to no magnesium. Calcitic limestone tends to dissolve faster than dolomitic limestone which can help adjust soil pH faster.

As mentioned above, a soil additive can include one or more additional components and/or ingredients such as synthetic nitrogen fertilizer, perlite, lime, dried distillers' grains, vermiculite, humic acids, beneficial microorganisms, micronutrients, urine, one or more stillage compositions, anaerobic digestion digestate composition, lignin, mushroom phymix, phosphorus-solubilizing bacteria, seaweed extract, organic fertilizer, compost (including Bokashi compost), manure, and combinations thereof. Table 1 lists some of these other potential materials and their potential benefits in soil additives according to the present disclosure.

TABLE 1
Other components

| Component | Potential Benefit |
|---|---|
| Nitrogen fertilizer | Provide essential macronutrient nitrogen |
| Perlite | Improve soil structure, drainage, reduce compaction |
| Vermiculite | Improve soil structure, drainage, reduce compaction |
| Agricultural lime | Increase pH of acid soils, provide calcium, improve |
| | water penetration, improve uptake of macronutrients |
| Distillers' grains | Provide nutrition for beneficial microorganisms |
| Humic acids | Promote bioavailability of nutrients |
| Beneficial | Solubilizing macronutrients, nitrogen fixing |
| microorganisms | (e.g., mycorrhizae, rhizobia) |
| Micronutrients | Provide boron, copper, iron, zinc, cobalt, |
| | molybdenum, manganese, and other micronutrients |
| Urine | Provides nitrogen, phosphorus, and micronutrients |

A soil additive can be formulated using one or more components and/or ingredients described above. In some embodiments, a soil additive is a blend or mixture of different powders. For example, a soil additive can be a mixture or blend of diatomaceous earth ingredient powder, calcium sulfate ingredient powder (e.g., gypsum powder), and biochar ingredient powder. In some embodiments, a soil additive is a blend or mixture of different discrete units. For example, a soil additive is a mixture of a first plurality of discrete units, a second plurality of discrete units, and a third plurality of discrete units. The first plurality of discrete units include diatomaceous earth ingredient powder, the second plurality of discrete units include calcium sulfate ingredient powder; and the third plurality of discrete units include biochar ingredient powder. In some embodiments, a soil additive is a plurality of the same discrete units, where each discrete unit is a mixture of different ingredients. For example, a soil additive is a plurality of discrete units, where each discrete unit comprises a mixture of diatomaceous earth ingredient powder; calcium sulfate ingredient powder; and biochar ingredient powder.

In some embodiments, a soil additive is a powder formed by grinding or milling previously formed discrete units, where each discrete unit is a mixture of different components.

In more detail, in some embodiments, a soil additive can be formulated as a blend or mixture of diatomaceous earth ingredient powder; calcium sulfate ingredient (e.g., gypsum) powder; and biochar ingredient powder. The weight amounts or weight ratios of each component can vary. In some embodiments, the composition of the powder mixture is the same as the soil additive applied to the soil because, e.g., the powder mixture, or discrete units thereof, is the soil additive. In some embodiments, the composition of the powder mixture may be slightly different from the soil additive depending on the one or more binders and/or one or more optional additives that may be used to form a powder mixture into discrete units as the soil additive. In some embodiments, the diatomaceous earth ingredient powder is present in the soil additive in an amount from 10-80% dry weight basis (dwb), the calcium sulfate ingredient powder is present in the soil additive in an amount from 10-80% dwb, and the biochar ingredient is present in the soil additive in an amount from 10-80% dwb. In some embodiments, the diatomaceous earth ingredient powder is present in the soil additive in an amount from 25-50% dry weight basis (dwb), the calcium sulfate ingredient powder is present in the soil additive in an amount from 25-50% dwb, and the biochar ingredient is present in the soil additive in an amount from 25-50% dwb. In some embodiments, the diatomaceous earth ingredient powder is present in the soil additive in an amount from 20-30% dry weight basis (dwb), the calcium sulfate ingredient powder is present in the soil additive in an amount from 20-30% dwb, and the biochar ingredient is present in the soil additive in an amount from 40-60% dwb. In some embodiments, the diatomaceous earth ingredient powder is present in the soil additive in an amount from 40-60% dry weight basis (dwb), the calcium sulfate ingredient powder is present in the soil additive in an amount from 20-30% dwb, and the biochar ingredient is present in the blend or soil additive in an amount from 20-30% dwb. In some embodiments, the diatomaceous earth ingredient, the calcium sulfate ingredient powder, and the biochar ingredient can be present in approximately equal amounts by weight. For example, the diatomaceous earth ingredient powder is present in the soil additive in an amount from 25-40% dry weight basis (dwb), the calcium sulfate ingredient powder is present in the soil additive in an amount from 25-40% dwb, and the biochar ingredient is present in the soil additive in an amount from 25-40% dwb. As another example, the diatomaceous earth ingredient powder is present in the soil additive in an amount from 30-35% dry weight basis (dwb), the calcium sulfate ingredient powder is present in the soil additive in an amount from 30-35% dwb, and the biochar ingredient is present in the soil additive in an amount from 30-35% dwb. In some embodiments, a soil additive according to the present disclosure “consists essentially of” diatomaceous earth ingredient powder; calcium sulfate ingredient (e.g., gypsum) powder; and biochar ingredient powder. In some embodiments, a soil additive according to the present disclosure “consists essentially of” diatomaceous earth ingredient powder; calcium sulfate ingredient (e.g., gypsum) powder; biochar ingredient powder, and binder. The expression “consisting essentially of” here indicates that an additional ingredient may be included in a soil additive in addition to diatomaceous earth ingredient powder; calcium sulfate ingredient (e.g., gypsum) powder; and biochar ingredient powder, and optionally binder, unless an object of the present disclosure is impaired such as relatively robust biomass production during drought conditions, similar biomass yields with less fertilizer, and the like. For example, an ingredient that is usually expected to be included in the relevant field to which the present disclosure pertains (such as an inevitable impurity, for example) may be included as the additional ingredient.

Soil additives according to the present disclosure can be made using a variety of methods. The method selected can depend on one or more factors such as the ingredients used to make the soil additive, the final physical form that is desired for the soil additive, and the like.

The components or ingredients of a soil additive according to the present disclosure may be blended or mixed together to form a mixture prior to application to soil. For example, a DE powder, a gypsum powder, and a biochar ingredient powder can be blended together to form a mixture as a soil additive for application to soil.

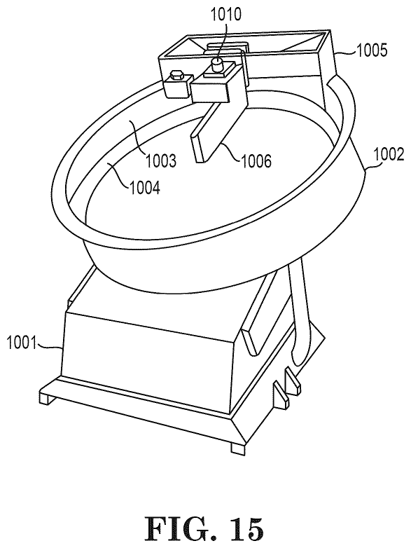

Soil additives in powder form can enhance effectiveness in the soil, but can increase the difficulty of handling, mixing, storing, transporting, and/or applying the additive to the soil by hand and/or using modern agricultural equipment, e.g., planters. In some embodiments, a powder or mixture of different powders can be formed into discrete units, which are solid forms of material formed by a variety of equipment. The discrete units are repeating units of a general shape and/or size that can be referred to as pellets, prills, granules, extrusions, or other discrete units such that each unit contains the component blend. Formed discrete units are more easily stored, shipped, handled, and applied than free-flowing powder. Non-limiting examples of equipment that can be used to form a soil additive mixture into discrete units include an agglomerator, a pan granulator, a pelletizer, a prilling machine, and the like. FIG. 15 shows an example of a pan granulator (also known as a disc pelletizer) that can be used to form granules. A pan granulator is a type of agitation agglomeration equipment that can form granules (pellets) via tumble growth, not pressure.

Forming the discrete units may be facilitated with one or more binders to wet and/or bind the components together. Non-limiting examples of binders include water, molasses, lignosulphonate, polyvinyl alcohol, one or more stillage compositions, and combinations thereof.

As used herein, a “stillage composition” refers to a back-end composition of a fermentation process after separating (e.g., via distillation) one or more bioproducts from beer to form at least one target bioproduct stream (e.g., ethanol) and one or more co-product streams (e.g., whole stillage). A stillage composition can include whole stillage, at least one stillage composition derived from whole stillage, and combinations thereof. Non-limiting examples of a stillage composition include at least one of whole stillage, thin stillage, defatted thin stillage, concentrated thin stillage (syrup), defatted syrup, defatted emulsion, clarified thin stillage, distiller's oil, distiller's grain, distiller's yeast, and combinations thereof. Defatted thin stillage, defatted syrup, and defatted emulsion are examples of stillage compositions that remain after fat (e.g., corn oil) has been separated therefrom, respectively, and each can be referred to as a “defatted stillage composition.” Although not shown, in some embodiments, defatted thin stillage can be formed by separating fat from thin stillage via one or more centrifuges.

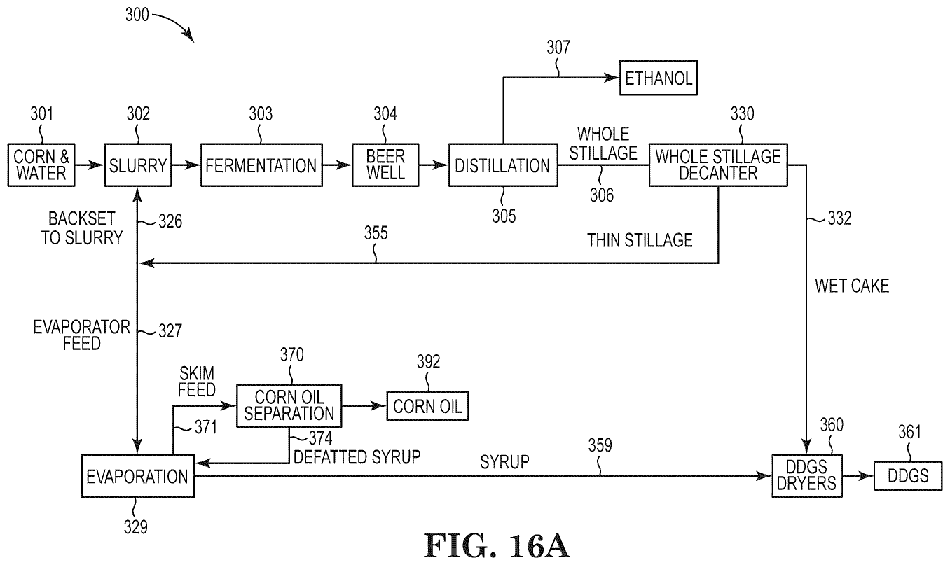

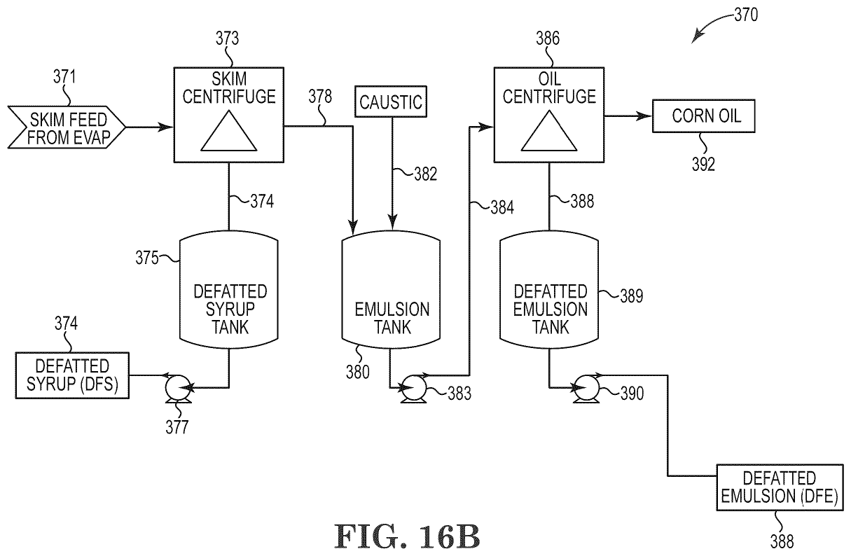

FIG. 16A illustrates an example of dry-grind corn ethanol biorefinery as a bioprocessing facility 300 that produces stillage compositions described above. The bioprocessing facility 300 includes a “front end” and a “back end.” The front end includes distillation system 305 and upstream from distillation system 305. As shown in FIG. 16A, the front end starts with adding ground corn and water 301 to a slurry tank 302, which is fed to a fermentation system 303 that ferments sugars into a beer that includes ethanol and carbon dioxide. Beer is transferred to a beer well 304 and eventually to a distillation system 305 where ethanol 307 is separated from beer to form whole stillage 306.

Whole stillage 306 is fed to decanter 330 to separate whole stillage 306 into wet cake 332 and thin stillage 355. The wet cake 332 and syrup 359 is dried in dryer system 360 to form dried distillers' grain with solubles (DDGS).

A portion 326 of the thin stillage 355 is transferred to the slurry tank 302 as backset, while the rest 327 of the thin stillage 355 is transferred to an evaporation train 329 that may include 4 to 8 evaporators in series (depending on plant size) to remove water and form syrup 359. Prior to reaching the end of the evaporator train 329, a semi-concentrated syrup (“skim feed”) 371 is removed and sent to corn oil separation system 370 which removes corn oil product 392.

The corn oil separation system 370 is described in more detail using FIG. 16B. As shown in FIG. 16B, the skim feed 371 is separated in a “skim” centrifuge 373 into an emulsion 378 and defatted syrup 374. The defatted syrup 374 can accumulate in defatted syrup tank 375 and defatted syrup 374 is eventually returned to the evaporator train 329 via pump 377, where a final syrup 359 is sent to dryer system 360 to form DDGS 361 as shown in FIG. 16A. The emulsion 378 is combined with caustic 382 in emulsion tank 380 to help “break” the emulsion into an oil phase and aqueous phase that are more easily separated from each other. The treated emulsion 384 is pumped via pump 383 to oil centrifuge 386, wherein the treated emulsion 384 is separated into a corn oil product 392 and defatted emulsion 388. The defatted emulsion 388 can accumulate in defatted emulsion tank 389 and defatted emulsion 388 can be pumped via pump 390 to any desired location. The skim centrifuge 373 and oil centrifuge 386 can be disk-stack centrifuges.

In some embodiments, a free-flowing powder can be combined with at least one stillage composition from an ethanol production process in a manner to form discrete units as soil additives. In some embodiments, a free-flowing powder form is combined with a stillage composition in a weight ratio from 0:100% to 100:0%, from 20:80% to 80:20%, from 40:60% to 60:40%, or even 50:50%.

Referring to FIG. 15, a pan 1002 is tiltably and rotatably mounted on base 1001. Pan 1002 has an inner side surface 1003, an inner bottom surface 1008 and a chamfer 1004 between the inner side surface and the inner bottom surface. Frame 1005 is supported above pan 1002. An arm 1006 (scraper or plow) is a vane-type component that can control the material layer as it tumbles over the bottom surface of pan 1002. As shown, arm 1006 is adjustable by being movable about pin 1010. Motor (not shown) can cause pan 1002 to rotate so that cause material to form pellets via tumble growth as pan 1002 rotates. For illustration purposes, biochar ingredient powder, diatomaceous earth ingredient powder, gypsum powder, and a liquid binder such as water can be fed onto the pan 1002 as it rotates, thereby causing the material to tumble and grow to form pellets by agglomeration, which combines and binds smaller solid particles (fines) together using liquid binder. The arm 1006 helps to remove buildup on the ban bottom and directs the pellets into separate streams as they grow in size. Eventually, the pellets grow to a size that causes them to exit over the side of the pan for collection. Pellet size can be controlled by adjusting the arm spacing from the inner bottom surface, the pan slope angle, rotation speed, time, moisture, temperature and feed rate of material onto the pan. Pelleting could also form coated seeds, if desired, as discrete units (pellets) having a noticeable change the shape, size, and/or weight of the coated seed as compared to the uncoated seed.

If desired, the discrete units can be dried after being formed. Drying can include using a dryer and heated gas, or simply blowing air at ambient temperature over the discrete units until a desired level of moisture removal has occurred. In some embodiments, discrete units have a moisture content of 20% or less, 15% or less, 10% or less, or even 5% or less by total weight of the discrete units.

The discrete units can be formed to not break down to an undue degree during storage, handling, and transportation, but break down after application in the soil into their original fine powder form. One exemplary mechanism for breaking down may include uptake of water causing swelling of the unit and separation of component particles. Another exemplary mechanism for breaking down may include thermal (solar) and/or moisture degradation, or solubilization, of a binder used in forming the units. It is noted that if too much moisture is present during storage, the discrete units may “cement” or fuse together to an undue degree, making subsequent application to soil challenging.

In some embodiments, one or more ingredients of a soil additive according to the present disclosure can be incorporated into a slurry (or solids suspension) or other liquid form prior to use. A solids suspension refers to maintaining a slurry of solids particles in a liquid. Depending on the particle size of a given ingredient, one or more ingredients can be micronized into a very fine powder to facilitate forming a solids suspension. As one example, a DE powder and/or a biochar ingredient powder can be formed into a solids suspension. If the particle size of the gypsum powder is too large it may not form a solids suspension, in which case the gypsum powder can be separately applied to the soil according to an application rate as described herein. In the scenario just described, the soil additive according to the present disclosure would include a powder portion and a solids suspension portion. Each portion would be formulated to form an overall soil additive according to the present disclosure. Such a multi-part soil additive could be packaged, marketed, and/or sold as a kit. Alternatively, the gypsum can be micronized into a very fine powder that permits it to be formed into a solids suspension.

A soil additive according to the present disclosure can be applied to soil using a variety of techniques, which can be selected based on, e.g., form of the soil additive (e.g., powder and/or solids suspension), desired application rate, and/or desired proximity to planting crop seeds. Non-limiting examples of techniques for applying a soil additive according to the present disclosure to soil include hand application (e.g., in pots), broadcasting, placement, and/or fertigation. Broadcasting refers to uniformly distributing a soil additive (or composition that includes the soil additive) or an area of soil. Placement refers to applying a soil additive (or composition that includes the soil additive) in or near plant rows. Fertigation refers to adding a soil additive (or composition that includes the soil additive) into irrigation water as a solids suspension so that it can be applied through drip, furrow, and/or sprinkler systems.

In some embodiments, a liquid form of a soil additive according to the present disclosure could be fed to plant roots directly through liquid fertilizer, hydroponics, and/or acroponics.

A soil additive can be applied at a wide range of rates. If a soil is “disadvantaged,” it may be remediated by applying a higher rate of soil additive. In some embodiments, a soil additive according to the present disclosure can be applied to soil at a rate from 10-10,0000 pounds/acre, from 50-1,000 pounds/acre, from 50-500 pounds/acre, or even 50-100 pounds/acre.

A soil additive according to the present disclosure can also be included with other planting media besides soil such as potting media, hydroponics, coco-peat, sand, and the like.

Optionally, one or more synthetic nitrogen fertilizers and/or one or more non-synthetic nitrogen fertilizers can be applied to soil in addition to a soil additive according to the present disclosure. “Synthetic nitrogen fertilizer” refers to any solid or liquid substance that is more than five percent nitrogen by dry weight and is applied to soil as a source of nitrogen nutrition for plants. In fertilizer compositions, nitrogen can be reported in terms “total nitrogen,” which is the sum of all forms of nitrogen and can be described as total nitrogen=ammonia nitrogen (NH₃)+organic nitrogen (nitrogen in amino acids and proteins, which includes urea and uric acid)+nitrite (NO₂)+nitrate (NO₃). Non-limiting examples include manufactured urea, diammonium phosphate, and sulphate of ammonia. One example of making a synthetic nitrogen fertilizer includes combining nitrogen and hydrogen under high pressure to form ammonia. A synthetic nitrogen fertilizer can be applied soil before, at the same time, and/or after applying a soil additive according to the present disclosure. If applying a synthetic nitrogen fertilizer and soil additive to soil at the same time, they can be applied separately or combined into a single composition (e.g., mixture or granules) for application to the soil. Non-limiting examples of a non-synthetic nitrogen fertilizer includes manure, compost, and combinations thereof.

A synthetic nitrogen fertilizer can be applied at a variety of rates. In some embodiments, a synthetic nitrogen fertilizer can be applied at a rate of 50 to 220-pounds/acre. In some embodiments, in terms of pounds of synthetic nitrogen fertilizer per bushel yield goal, the synthetic nitrogen fertilizer can be separately applied, e.g., at a rate of 0.5-1.5 pounds of synthetic nitrogen fertilizer per bushel yield goal. Alternatively, in some embodiments, no synthetic nitrogen fertilizer is applied to soil at any time when using a soil additive according to the present disclosure.

Crop seeds or other planting material can be planted in soil before, during, and/or after treating the soil with a soil additive according to the present disclosure. For example, in some embodiments, crop seeds can be planted with a planter implement at the same time as applying a soil additive according to the present disclosure, and optionally synthetic nitrogen fertilizer (as described above), to soil. In an illustrative example, crop seeds may be planted utilizing a planter implement that simultaneously plants the crop seed and applies the soil additive. As another example, crops can be “top-dressed” with a soil additive according to the present disclosure, and optionally synthetic nitrogen fertilizer (as described above). Top dressing or top-dressed application means that the soil additive can be applied after the crop seeds have been planted or the crop or other planting material has been established. Planting material refers to seeds (crop seed), crops, seedlings, plantlets, cuttings, rooted cuttings, stem sections, tubers, perennial trees, and the like. Non-limiting examples of crops that can be top-dressed include trees such as fruit trees (e.g., avocado trees, coconut trees, citrus trees, and mango trees), coffee trees, tea trees, cashew trees, and the like; corn plants (maize); tomato plants; beans; potatoes; leafy vegetables; and the like.

The planted crop seeds can then be exposed to conditions (e.g., environmental conditions) to allow the corresponding plant to grow and mature in a manner so that it can be harvested. Advantageously, in some embodiments, a crop can be grown using a soil additive according to the present disclosure and 100% or less, 90% or less, 80% or less, 70% or less, 60% or less, 50% or less, 40% or less, or even 30% or less of synthetic nitrogen fertilizer as compared to a control crop grown with one hundred percent of the synthetic nitrogen fertilizer rate and without the soil additive while producing a yield of at least 80%, at least 90%, or at least 100% of a yield produced by the control crop.

In some embodiments, a soil additive according to the present disclosure may help reduce (control) or remediate biotic stress of a plant caused by one or more organisms (“pests” or “plant-parasitic organisms”) that may be present in soil and/or other planting media. As used herein, “biotic stress” refers to a state of a plant in which one or more organisms disrupt the metabolism of the plant, which can impact growth, vigor, and/or productivity to an undue degree. Non-limiting examples of such organisms include viruses, bacteria, fungi, nematodes, insects, arachnids, weeds, and combinations thereof. While not being bound by theory, it is believed that a soil additive according to the present disclosure may strengthen the plant's resistance to biotic stress caused by one or more organisms, as described above. Again, while not being bound by theory, it is believed that the silica content of DE can help make a plant more resistant to biotic stress discussed above. In some embodiments, a plant grown in the presence of a soil additive according to the present disclosure has a lower biotic stress as compared to a control plant grown in soil without the soil additive. In some embodiments, a crop can be grown in soil treated with the soil additive according to the present disclosure so that the plant has a lower number of plant-parasitic nematodes in its roots as compared to a control plant grown in soil without the soil additive. In some embodiments, the presence of active, plant-parasitic organisms in the soil can be determined (e.g., measured or predicted) before treating the soil with the soil additive. For example, the degree to which plant-parasitic organisms are present in an area may vary from season to season so it may be desirable to not treat the soil with a soil additive according to the present disclosure in a particular growing season that the plant-parasitic organisms are not troublesome to an undue degree. Determining whether to treat a soil with a soil additive according to the present disclosure for remediation purposes can involve evaluating one or more soil assays, plant analysis of plants growing in a soil (e.g., observing the presence of nematodes in the roots of plants growing in the field, observing lesions or root knots in germinating seedlings, and the like), observations from previous crop cycles, historical records, environmental conditions known to correlate to plant-parasitic organisms of interest, economic analysis of treatment cost, and combinations thereof. In some embodiments, because a soil additive according to the present disclosure has one or more additional benefits for soil (e.g., water retention), it may be desirable to apply the soil additive in a given year as an insect preventative for future growing seasons.

As another advantage, in some embodiments, plants grown with a soil additive according to the present disclosure can have stronger root systems and/or better nodulation (e.g., in beans) as compared to plants not grown with the soil additive. As yet another advantage, in some embodiments, a soil additive according to the present disclosure may remove carbon-dioxide from air. While not being bound by theory, it is believed that carbon dioxide can form carbonic acid when it contacts moisture in the atmosphere. Carbonic acid present in rain that contacts the ground may irreversibly bind to silicon present in a soil additive according to the present disclosure. As mentioned above, diatomaceous earth has a large amount of silica (silicon dioxide). Also, biochar tends to have silicon content.

### Example 1

Field Test—A trial was conducted growing corn with different formulations of a soil additive according to the present disclosure combined with varying levels of synthetic nitrogen. Two base formulations were prepared to which additional components were added. The base formulations are described in Table 2.

TABLE 2

| | Base Formulation: | Base Formulation: |
|---|---|---|
| Component | PS1(% by weight) | PS2 (% by weight) |
| DE ingredient | 50% | 25% |
| Gypsum | 25% | 25% |
| Biochar ingredient | 25% | 50% |

The DE was commercially obtained from Fertrell Company, Bainbridge, PA, under the tradename Perma-Guard™ diatomaceous earth ingredient, which is a fresh water DE.

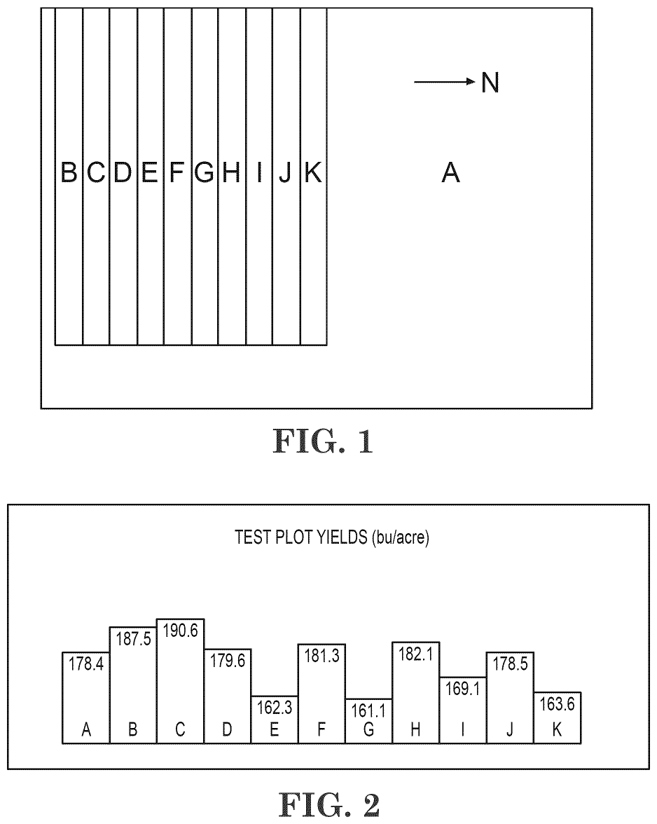

The gypsum was commercially obtained from EcoGEM. The gypsum was reported on the spec sheet from EcoGEM as having a calcium content of 22.4%; a sulfur content 17.8%; a calcium sulfate ingredient dihydrate content of 90%+; and a moisture content of 1.80%. The biochar ingredient was made by ARTi of Prairie City, IA, using a pyrolizer unit. Corn stover was hammermilled and then formed into biochar ingredient using the pyrolizer unit. A variety of soil amendments A-K were created as shown in Table 3 and used in corresponding plots illustrated in FIG. 1 (discussed below). The soil amendments A-K used various combinations of one or more of base formulation PS1, base formulation PS2, synthetic nitrogen fertilizer, microorganisms, and micronutrients.

Both the PS1 and PS2 formulations (each included DE ingredient powder, gypsum powder, and biochar ingredient powder) had a particle size distribution such that 100% by weight of the particles passed through a 35-mesh screen (500 microns); 91% weight of the particles passed through a 60-mesh screen (250 microns); 73% by weight of the particles passed through a 140-mesh screen (105 microns); and 64% by weight of the particles passed through a 270-mesh screen (53 microns).

The synthetic nitrogen fertilizer was a commercially available, dry granulated urea (46-0-0) (N-P-K), which corresponds to 46% by weight of nitrogen. The synthetic nitrogen fertilizer was included at either a half rate, full rate, or not at all. Per the label directions, the “full rate” corresponded to 200 pounds of nitrogen per acre and the “half rate” corresponded to 100 pounds of nitrogen per acre.

The beneficial microorganisms were commercially obtained from Biodyne® USA under the tradename BD-Biocast (1-0-0). The BD-Biocast (1-0-0) beneficial microorganisms product was applied according to the label dosing instructions or not at all. Per the label directions, the recommended dosing rate was 1 quart per acre.

The micronutrients were commercially obtained from BW Fusion, and was a liquid. The BW Fusion product label reported the following micronutrients: 2.0% of boron derived from boric acid; 0.5% of copper (0.5% chelated copper) derived from copper EDTA; 0.25% iron (0.25% chelated iron) derived from iron EDTA; 2.0% manganese (2.0% chelated manganese) derived from manganese EDTA; and 2.0% zinc (2.0% chelated zinc) derived from zinc EDTA. The micronutrients were included according to the label dosing instructions or not at all. Per the label directions, the recommended dosing rate was 3 quarts per acre.

Each soil amendment was mixed in a cement mixer. If beneficial microorganisms were included, a concentrated liquid suspension was sprayed into the cement mixer after the other ingredients were introduced into the cement mixer and while mixing the other ingredients.

TABLE 3

| | Synthetic | | | | | |
|---|---|---|---|---|---|---|
| Soil | Nitrogen | | | Beneficial | | Test |
| Amendment | Fertilizer | PS1 | PS2 | Microorganisms | Micronutrients | Plot |
| (Plot) | (rate) | (lbs) | (lbs) | (spray) | (lbs) | Acres |
| A | Full | 0 | 0 | No | No | 3.308 |
| B | Half | 0 | 36 | Yes | Yes | 0.396 |
| C | Half | 0 | 36 | No | No | 0.396 |
| D | Half | 36 | 0 | Yes | Yes | 0.396 |
| E | None | 36 | 0 | Yes | Yes | 0.396 |
| F | Half | 36 | 0 | No | Yes | 0.396 |
| G | None | 36 | 0 | No | Yes | 0.396 |
| H | Half | 36 | 0 | Yes | No | 0.396 |
| I | None | 36 | 0 | Yes | No | 0.396 |
| J | Half | 36 | 0 | No | No | 0.396 |
| K | None | 36 | 0 | No | No | 0.396 |

FIG. 1, illustrates the test plot layout. Plots labeled A-K were amended with the corresponding soil amendment formulation from Table 3. The plots were planted with Dekalb 5087 corn seed at a 30-inch row spacing 30,000 seeds per acre utilizing a 4-row planter which also applied the PS1 or PS2 formulation according to Table 3 as a powder 2 inches on each side of and 2 inches below the seed via the planter's integrated dry fertilizer delivery system. The beneficial microorganisms and micronutrients were applied according to Table 3 also at the time of seed planting. The synthetic nitrogen fertilizer was applied according to Table 3 after the plant was established later in the growing season. The rows all were run east and west. Areas B-K were 36 row strips arranged side-by-side from south to north. Area A enclosed areas B-K to the south, east, and north.

The corn was grown without irrigation and harvested 134 days after planting and the results are shown in FIG. 2 for each test plot area. The bars indicate the yield in bushels per acre. The test plots utilizing half rate nitrogen performed as well as or better than the area receiving full rate nitrogen and in these results the performance was independent of added beneficial microorganisms and/or micronutrients.

### Example 2

This prophetic example illustrates a rate of application of a soil additive according to the present disclosure to soil. In this illustrative example soil is treated with a soil additive according to the present disclosure and synthetic nitrogen fertilizer. The soil is treated with the soil additive at a rate of 10-10,000 pounds/acre and the synthetic nitrogen at a rate of 50-220 pounds/acre. A crop is grown in the treated soil.

### Example 3

This prophetic example illustrates a how synthetic nitrogen fertilizer can be reduced using a soil additive according to the present disclosure. In this illustrative example soil is amended with a soil additive according to the present disclosure and fifty percent less (half of the recommended rate) synthetic nitrogen fertilizer as compared to a control crop grown with 100 percent of the synthetic nitrogen fertilizer (full recommended rated) and without the soil additive. The amended crop produces similar (at least 80% of the) yield as the control crop.

### Example 4

In another illustrative prophetic example, a soil additive according to the present disclosure is added to soil to remediating biotic stress of a plant caused by plant-parasitic organisms. While not being bound by theory, it is believed that the diatomaceous earth ingredient disperses in the soil and helps a plant be relatively resistant to biotic stress caused by plant-parasitic organisms, e.g., one or more nematodes, while not harming beneficial organisms, e.g., earthworms. A soil additive formed into discrete units (e.g., as described in Example 5) breaks down after application to allow the constituent particles to disperse within the soil.

### Example 5

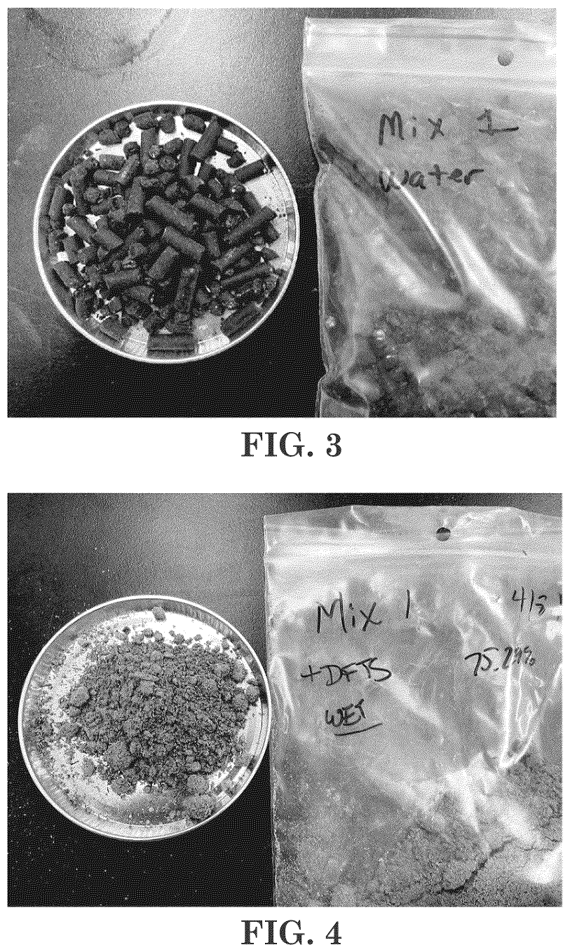

This example illustrates using water to form a mixture of powders into pellets as a soil additive according to the present disclosure. In this illustrative example, finely powdered DE, finely powdered gypsum, and biochar ingredient made from stalks, leaves, husks and cobs of the corn plant were combined per the PS1 formulation in Table 2 to form a mixture. Samples of this mixture were moistened with water and pelletized in a flat-plate, pellet mill to evaluate moisture levels that facilitate forming pellets. The flat-plate, pellet mill that was used is s CPM mill is similar to a USA Pellet Mill, model MKFD120B mill, which is typical for a small farm to produce feed on-site. It was determined that pellets started to form at a moisture level of approximately 18% by weight. Uniform, consolidated pellets having sufficient structural integrity so as not to easily crumble or release fines began to form from mixtures with a moisture level of approximately 25% by weight. The pellets resulting from a mixture moistened with water to 25% moisture had a final moisture content of 22% by weight (78% by weight solids) after cooling, and are shown in FIG. 3. Heat was generated due to pelletizing. No external heat was applied.

### Example 6

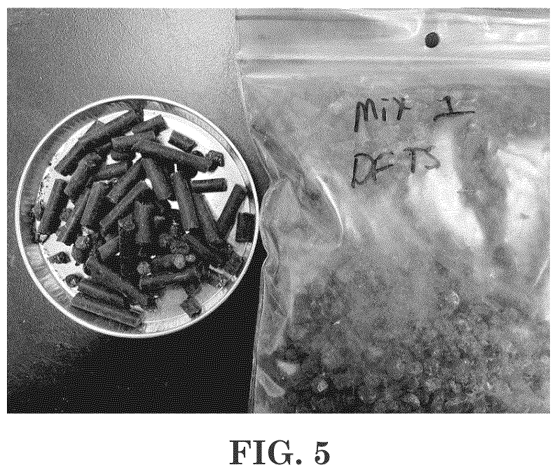

This example illustrates using defatted thin stillage to form a mixture of powders into pellets as a soil additive according to the present disclosure. In this illustrative example, finely powdered DE, finely powdered gypsum, and biochar ingredient made from stalks, leaves, husks and cobs of the corn plant were combined per the PS1 formulation in Table 2 to form a mixture as shown in FIG. 4. An approximately 50:50 mixture of defatted thin stillage (about 8-9% by weight solids) and water was prepared to a moisture content of content of about 96% by weight (about 4% by weight solids). The dry mixture was moistened with the water and defatted thin stillage mixture to a moisture content of 25% by weight (75% by weight solids). The moistened mixture was pelletized in a flat plate pellet mill to produce pellets as shown in FIG. 5 having a moisture content of 17% by weight (83% by weight solids) after cooling. The pellets were hard and smooth and harder than the pellets moistened with water alone in Example 5.

### Example 7

This example illustrates using water to form another mixture of powders into pellets as a soil additive according to the present disclosure. In this illustrative example, finely powdered DE, finely powdered gypsum, and biochar ingredient made from stalks, leaves, husks and cobs of the corn plant were combined per the PS2 formulation in Table 2 to form a mixture. The powdered mixture was moistened with the water to a moisture content of 25% by weight (75% by weight solids). The moistened mixture was pelletized in a flat plate pellet mill to produce pellets followed by cooling.

### Example 8

This example illustrates using defatted thin stillage to form another mixture of powders into pellets as a soil additive according to the present disclosure. In this illustrative example, finely powdered DE, finely powdered gypsum, and biochar ingredient made from stalks, leaves, husks and cobs of the corn plant were combined per the PS2 formulation in Table 2 to form a mixture. An approximately 50:50 mixture of defatted thin stillage and water was prepared to a moisture content of content of about 96% by weight (about 4% by weight solids). The dry mixture was moistened with the water and defatted thin stillage mixture to a moisture content of 25% by weight (75% by weight solids). The moistened mixture was pelletized in a flat plate pellet mill to produce pellets having a moisture content of 11% by weight (89% by weight solids) after cooling. The pellets were hard and smooth and harder than the pellets moistened with water alone.

### Example 9

Samples of each of the PS1 and PS2 base formulations described in Table 2, as well as samples of each of the individual components (DE ingredient, gypsum, and biochar ingredient) in Table 2, were combined with sand at an approximate rate corresponding to 10 tons per acre of field application, i.e., approximately 1% rate dry weight basis. The PS1 and PS2 samples were each combined with Sand 1. The biochar ingredient, DE ingredient, and gypsum were each combined with Sand 2. Samples of the neat sand and the combinations were submitted for soil analysis to Midwest Laboratories of Omaha, Nebraska using their S3C soil testing package. The results are shown in Tables 4a and 4b.

TABLE 4a

| | OM | P1 | P2 | K | Mg | Ca | Na | | | | % | % |
|---|---|---|---|---|---|---|---|---|---|---|---|---|
| Sample | ppm | ppm | ppm | ppm | ppm | ppm | ppm | pH | BpH | CEC | K | Mg |
| Sand 1 | 0.1 | 4 | 13 | 25 | 75 | 1474 | 30 | 9.1 | 7.1 | 8.2 | 0.8 | 7.6 |
| PS1 + Sand 1 | 0.1 | 7 | 21 | 53 | 77 | 1950 | 33 | 8.8 | 7.1 | 10.7 | 1.3 | 6 |
| PS2 + Sand 1 | 0.3 | 9 | 21 | 104 | 79 | 1911 | 26 | 8.7 | 7.1 | 10.6 | 2.5 | 6.2 |
| Sand 2 | 0.2 | 5 | 14 | 19 | 74 | 1462 | 26 | 9 | 7.1 | 8.1 | 0.6 | 7.6 |
| Biochar ingredient + | 0.4 | 11 | 30 | 218 | 94 | 1181 | 27 | 9.2 | 7.1 | 7.4 | 7.6 | 10.6 |
| Sand 2 | | | | | | | | | | | | |
| DE ingredient + | 0.2 | 4 | 16 | 25 | 72 | 1439 | 29 | 9.1 | 7.1 | 8 | 0.8 | 7.5 |
| Sand 2 | | | | | | | | | | | | |
| Gypsum + Sand 2 | 0.1 | 6 | 14 | 16 | 61 | 3597 | 25 | 8.5 | 7.1 | 18.6 | 0.2 | 2.7 |

TABLE 4b

| | | | | | | | | | | | Sol | |
|---|---|---|---|---|---|---|---|---|---|---|---|---|
| | | | | NO3 | S | Zn | Mn | Fe | Cu | B | Salts | Bi |
| Sample | % Ca | % H | % Na | ppm | ppm | ppm | ppm | ppm | ppm | ppm | ppm | ppm |
| Sand 1 | 90 | 0 | 1.6 | 1 | 19 | 0.1 | 3 | 9 | 0.1 | 0 | 0.1 | 4 |
| PS1 + Sand 1 | 91.4 | 0 | 1.3 | 1 | 406 | 0.1 | 4 | 17 | 0.1 | 0 | 0.5 | 6 |
| PS2 + Sand 1 | 90.2 | 0 | 1.1 | 1 | 520 | 0.3 | 5 | 12 | 0.2 | 0 | 0.5 | 7 |
| Sand 2 | 90.4 | 0 | 1.4 | 2 | 10 | 0.1 | 5 | 8 | 0.1 | 0 | 0.1 | 15 |
| Biochar ingredient + | 80.2 | 0 | 1.6 | 2 | 14 | 0.3 | 8 | 9 | 0.2 | 0 | 0.2 | 18 |
| Sand 2 | | | | | | | | | | | | |
| DE ingredient + | 90.1 | 0 | 1.6 | 2 | 89 | 0.1 | 5 | 6 | 0.1 | 0 | 0.1 | 7 |
| Sand 2 | | | | | | | | | | | | |
| Gypsum + Sand 2 | 96.5 | 0 | 0.6 | 2 | 2311 | 0.1 | 4 | 7 | 0.1 | 0 | 0.6 | 5 |

This analysis shows the potential soil effects of the individual components and the formulations. The columns refer to the amount of each measured component in an extract of the sample. OM is the amount of organic matter in the sample. P1 is phosphorus as extracted from the sample using the standard Bray P1 extractant. P2 is phosphorus as extracted from the sample using the more acidic Bray P2 extractant. K is total potassium. Mg is total magnesium. Ca is total calcium. Na is total sodium. pH is the pH of the sample. BpH is buffer pH which is a measure of the residual or reserve soil acidity, i.e., a measure of the amount of lime needed to increase soil pH to a desirable level. CEC is the cation exchange capacity of the sample and is the total capacity of the sample to hold exchangeable cations. It is a measure of the capacity the soil to hold nutrients. The % K, % Mg, % Ca, % H and % Na is a measure of the percentage of the soil colloids that are occupied by each element. NO₃ is a measure of nitrate and ammonia, i.e., the available nitrogen. S is total sulfur. Zn is total zinc. Mn is total manganese. Fe is total iron. Cu is total copper. B is total boron. Sol Salts or total soluble salts refer to the total amount of salt dissolved in a sample extract expressed in parts per million (ppm). The salts include substances that form common table salt (sodium and chloride) as well as calcium, magnesium, potassium, nitrate, sulfate and carbonates. Bicarbonate index (BI) is a measure of the soil reservoir of basic material in terms of “free lime” or excess mineral limestone particles, which will serve to resist change in soil pH. BI is typically reported in parts per million (ppm).

### Example 11

This example illustrates using water to form a mixture of powders and commercial fertilizer prills into a soil additive according to the present disclosure in the form of an agglomerated mixture and granules.

Biochar ingredient, diatomaceous earth ingredient, and gypsum were combined in equal weight amounts (⅓, ⅓, and ⅓) to form a soil additive and blended with synthetic nitrogen fertilizer prills in weight ratio of 5:8. The synthetic nitrogen fertilizer prills included 37.5% by weight urea and 62.5% by weight monoammonium phosphate (MAP). The DE ingredient, gypsum, and biochar ingredient were from the same sources used in Example 1.

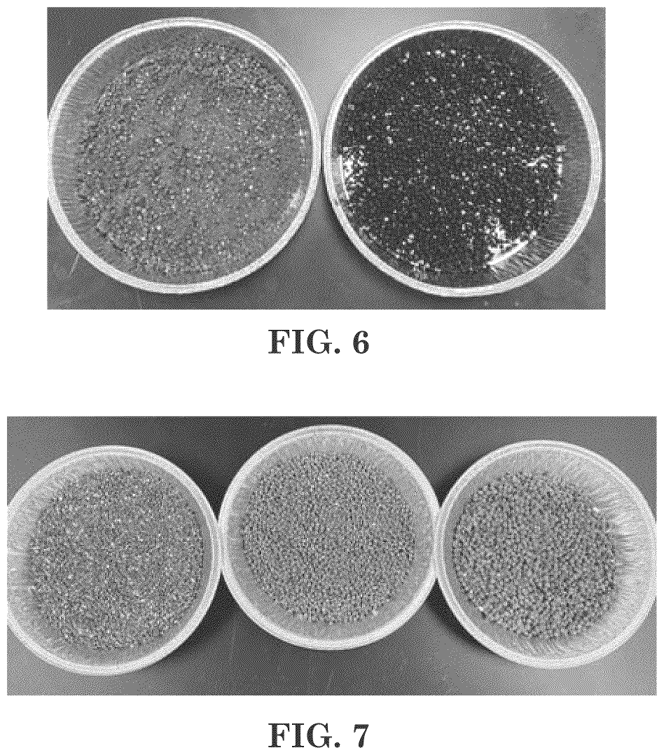

The commercial fertilizer prills and soil additive were added to a cement mixer and the mixer was turned on so that the revolving drum mixed these ingredients until they were homogenously mixed. Water was added to the cement mixer at a rate of 3-5% moisture by weight to act as a binder to agglomerate the ingredients. It is noted that other potential binders that could be used alone or in combination with water include, e.g., molasses, lignosulphonate, polyvinyl alcohol, one or more stillage compositions (e.g., one or more ethanol stillage compositions) such as thin stillage, defatted thin stillage, syrup or corn oil. The sample on the left in FIG. 6 shows the agglomerated mixture after mixing with the cement mixer.

The agglomerated mixture from the cement mixer was used as a soil amendment and fertility treatment in a commercial corn yield trial. The agglomerated mixture was applied through a planter-mounted fertilizer delivery system approximately 3 inches from the row with a target rate of 100 lbs of soil additive per acre and 160 lbs of fertilizer, which corresponds to the weight ratio of 5:8 mentioned above. The mixture remaining after planting was used in granulation as described below.

For granulation, the previous blend was slowly added to the pan granulator shown in FIG. 15 and sprayed with water while the disc was rotating. Granules formed on the rotating surface and were collected in the collection bin. The photo on the right in FIG. 6 shows the blend after granulation. Once the granulation was complete, all the granules were transferred into aluminum trays and dried at 100C for 24 hours. This process formed granules with a range of particle sizes. The granules were size classified with a set of screens. FIG. 7 shows the granules of different sizes after drying. It is noted that, in some embodiments, the size of the granules are targeted to be within a range that can be used in existing machinery that spreads commercial fertilizers (e.g., 2-5 mm granule size). Any overs/unders can be recycled and used to make additional granules.

### Example 12

A greenhouse study was conducted to evaluate formulating a soil additive to reduce synthetic nitrogen. The study was conducted growing oats in a greenhouse with different formulations of a soil additive according to the present disclosure combined with varying levels of synthetic fertilizer. Two base formulations were prepared and tested in combination with a full and reduced rate of synthetic nutrients. The base formulations are described in Table 5.

TABLE 5

| Component | Base Formulation: PS1 | Base Formulation: PS2 |
|---|---|---|
| DE ingredient | 50% wt. | 25% wt. |
| Gypsum | 25% wt. | 25% wt. |
| Biochar ingredient | 25% wt. | 50% wt. |

The soil additives and the individual ingredients being tested were included at a rate equivalent to 10 imperial tons per acre. The DE ingredient, gypsum, and biochar ingredient were from the same sources used in Example 1.

The synthetic fertilizer rates used in this test were achieved through the use of Urea (46-0-0), Diammonium Phosphate (DAP, 18-46-0) and Potash (0-0-60). Two different rates of synthetic fertilizers were tested in combination with the soil additive based on a recommended full rate of 62 pounds per acre equivalent of Phosphate (P₂O₅), 119 pounds per acre equivalent of Potash (K₂O) and 156 pounds per acre equivalent of Nitrogen (N). The rates tested were scale equivalents of full rate and half of the full rate. For any soil additives or ingredients that contained N, P or K, the respective synthetic fertilizer was reduced by a corresponding amount so that the total added N, P, and K corresponded to the rates mentioned above. The rates of synthetic fertilizer inclusion is shown below in Table 6.

TABLE 6

| | | | | | | | Soil ingredient |
|---|---|---|---|---|---|---|---|
| Soil treatment − control; | DAP | Potash | Urea | | | | or Soil Additive |
| soil ingredient + | (grams per 10 | (grams per 10 | (grams per 10 | | | | (grams per |
| fertilizer; or soil | kg of sand | kg of sand | kg of sand | N | P | K | 10 kg of sand |
| additive + fertilizer | growth medium) | growth medium) | growth medium) | ppm | ppm | ppm | growth medium) |
| Control | 0.00 | 0.00 | 0.00 | 0.00 | 0.00 | 0.00 | 0.00 |
| Biochar ingredient + | 0.17 | 0.25 | 0.36 | 19.53 | 7.76 | 16.49 | 25.03 |
| fertilizer | | | | | | | |
| PS1 + .5 fertilizer | 0.08 | 0.12 | 0.18 | 9.76 | 3.88 | 8.25 | 25.03 |
| PS1 + fertilizer | 0.17 | 0.25 | 0.36 | 19.53 | 7.76 | 16.49 | 25.03 |
| PS2 + .5 fertilizer | 0.08 | 0.12 | 0.18 | 9.76 | 3.88 | 8.25 | 25.03 |
| PS2 + fertilizer | 0.17 | 0.25 | 0.36 | 19.53 | 7.76 | 16.49 | 25.03 |
| DE ingredient + | 0.17 | 0.25 | 0.36 | 19.53 | 7.76 | 16.49 | 25.03 |
| fertilizer | | | | | | | |
| Gypsum + fertilizer | 0.17 | 0.25 | 0.36 | 19.53 | 7.76 | 16.49 | 25.03 |

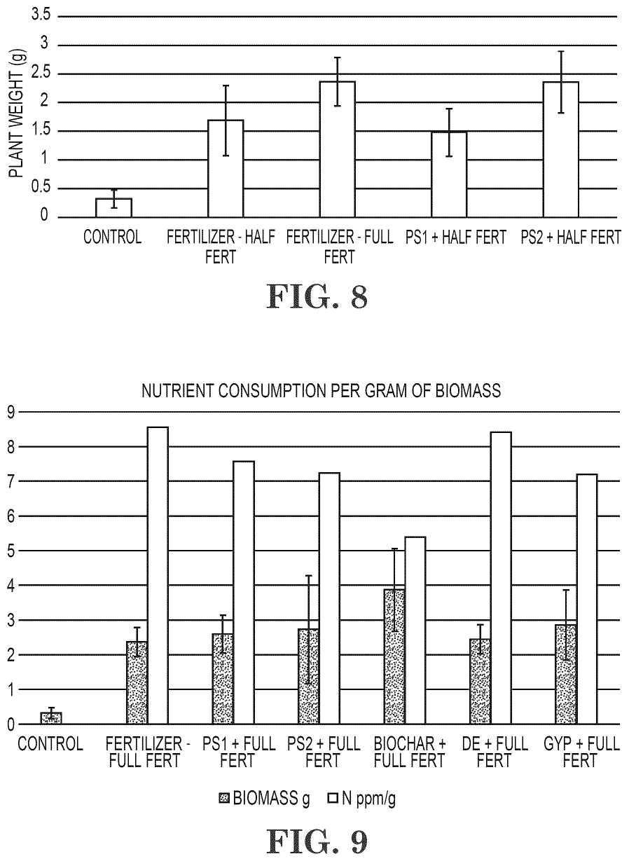

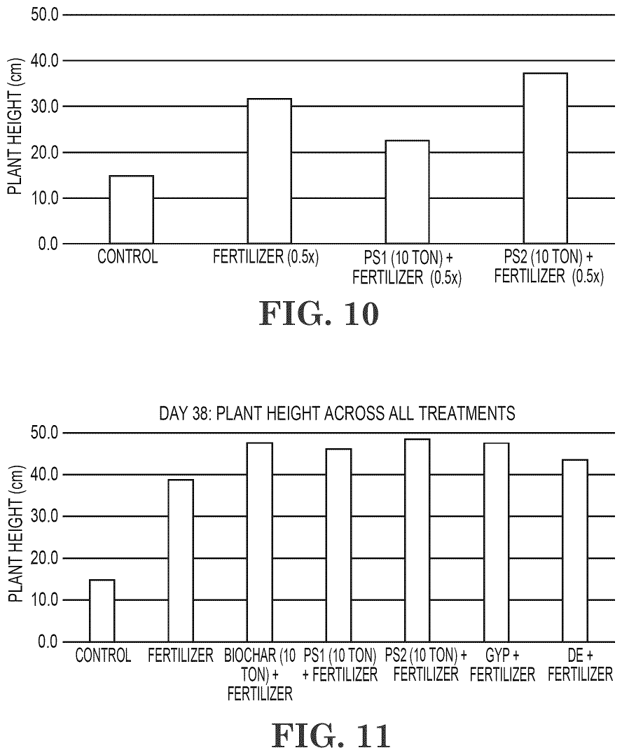

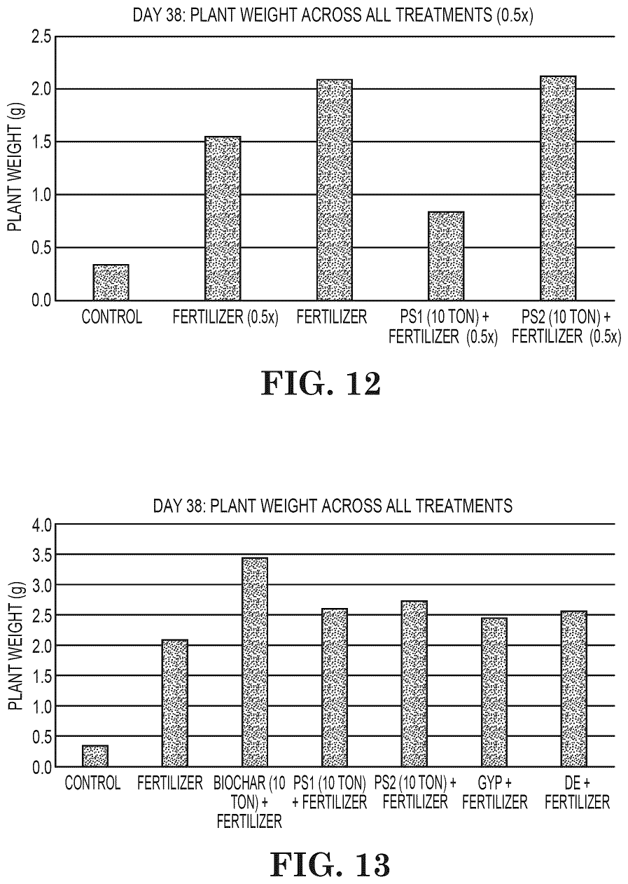

This trial was conducted in a greenhouse using a sand growth medium with each soil additive and synthetic fertilizer rate mixed in bulk and divided into 10 individual growth pots per variable. Each pot was then planted with a single oat seed and growth habit was monitored for a period of 38 days. The supplied moisture and light were consistent across the test pots. Plants were harvested by cutting the plants at the soil line. Harvested biomass was weighed and submitted to Midwest Labs for a tissue analysis. The remaining growth medium was separated from root mass and submitted to Midwest labs for a soil analysis of remaining nutrients. The results of this trial are shown in FIGS. 8-13.

### Example 13

A greenhouse study was conducted to evaluate different combinations of the following three soil additive ingredients: 1) biochar made from corn stover, 2) gypsum, and 3) diatomaceous earth (DE). This study was conducted by growing oats in a greenhouse setting using sand as a growth medium. The biochar, gypsum, and DE, were tested in combinations of two and as a formulation of all three at two different rates of fertilizer and with the inclusion of a drought condition as described below in Table 7 below. The DE ingredient, gypsum, and biochar ingredient were from the same sources used in Example 1.

The synthetic fertilizer rates used in this test were achieved through the use of urea (46-0-0), diammonium phosphate (DAP, 18-46-0) and potash (0-0-60). For any soil additives that contained N, P or K, the respective synthetic fertilizer (urea, DAP, and/or potash) was reduced by a corresponding amount so that the total added N, P, and K corresponded to the rates mentioned below.

Two different rates of synthetic fertilizers were tested in combination with the soil additives based on a literature recommended full rate of 62 pounds per acre equivalent of phosphate (P₂O₅), 119 pounds per acre equivalent of potash (K₂O) and 156 pounds per acre equivalent of nitrogen (N). The amount of synthetic fertilizer added to each treatment were scale equivalents of full rate (100%) and half (50%) of the full rate and are shown in Table 7, where “g”=grams and “kg”=kilograms.

TABLE 7

| | | | Total Sand | | | | | | | Biomass |
|---|---|---|---|---|---|---|---|---|---|---|
| | Fert. | | Growth | | | | | | | Harvest - |
| Soil Additive | Rate | Water | Medium - | DE - | Biochar - | Gypsum | Urea | Potash | DAP | Avg |
| Treatment | (%) | (rate) | (kg) | (g) | (g) | (g) | (g) | (g) | (g) | (g)/plant |
| biochar | 50 | Full | 10 | | 100 | | 0.66 | 0.45 | 0.31 | 0.33 |
| DE | 50 | Full | 10 | 100 | | | 0.66 | 0.45 | 0.31 | 0.51 |
| Gypsum | 50 | Full | 10 | | | 100 | 0.66 | 0.45 | 0.31 | 0.63 |
| DE + biochar | 50 | Full | 10 | 100 | 100 | | 0.66 | 0.45 | 0.31 | 0.76 |
| DE + Gypsum | 50 | Full | 10 | 100 | | 100 | 0.66 | 0.45 | 0.31 | 0.75 |
| Gypsum + | 50 | Full | 10 | | 100 | 100 | 0.66 | 0.45 | 0.31 | 0.77 |
| biochar | | | | | | | | | | |
| Gypsum + | 50 | Full | 10 | 100 | 100 | 100 | 0.66 | 0.45 | 0.31 | 0.77 |
| biochar + | | | | | | | | | | |
| DE (PS3) | | | | | | | | | | |
| Untreated | 50 | Full | 10 | | | | 0.66 | 0.45 | 0.31 | 0.36 |
| Biochar - | 100 | Half | 10 | | 100 | | 1.31 | 0.91 | 0.62 | 0.02 |
| Drought | | | | | | | | | | |
| Comparison | | | | | | | | | | |
| DE - Drought | 100 | Half | 10 | 100 | | | 1.31 | 0.91 | 0.62 | 0.15 |
| Comparison | | | | | | | | | | |
| Gypsum - | 100 | Half | 10 | | | 100 | 1.31 | 0.91 | 0.62 | 0.09 |
| Drought | | | | | | | | | | |
| Comparison | | | | | | | | | | |
| DE + Biochar - | 100 | Half | 10 | 100 | 100 | | 1.31 | 0.91 | 0.62 | 0.13 |
| Drought | | | | | | | | | | |
| Comparison | | | | | | | | | | |
| DE + Gypsum - | 100 | Half | 10 | 100 | | 100 | 1.31 | 0.91 | 0.62 | 0.05 |
| Drought | | | | | | | | | | |
| Comparison | | | | | | | | | | |
| Gypsum + | 100 | Half | 10 | | 100 | 100 | 1.31 | 0.91 | 0.62 | 0.04 |
| Biochar - | | | | | | | | | | |
| Drought | | | | | | | | | | |
| Comparison | | | | | | | | | | |
| PS3 - Drought | 100 | Half | 10 | 100 | 100 | 100 | 1.31 | 0.91 | 0.62 | 0.22 |
| Comparison | | | | | | | | | | |
| Untreated - | 100 | Half | 10 | | | | 1.31 | 0.91 | 0.62 | 0.06 |
| Drought | | | | | | | | | | |
| Comparison | | | | | | | | | | |

The growth medium (sand), soil additive powder, and fertilizer (urea, potash, and DAP) for each treatment in Table 7 were mixed in bulk by hand and subdivided equally among 10 pots with one seed planted per pot.

“Full” (or “normal”) watering (“Water” in table 7) involved watering each pot with approximately 50 ml of water per pot twice per week until germination had been established, at which time the “full” watering continued with watering each corresponding pot with 50 ml of water twice per week while the “half” (or “drought comparison”) involved watering each corresponding pot with 50 ml of water once per week. Light and temperature were consistent across all pots. Plants were harvested by cutting the plants at the soil line.

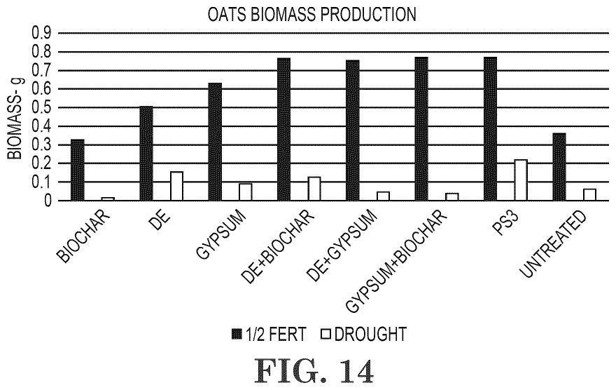

Harvested biomass was weighed. The results of this trial are shown in FIG. 14.

As can be seen in FIG. 14, the combinations of DE+biochar; DE+gypsum; gypsum+biochar; and DE+biochar+gypsum (PS3) all had similar biomass production when combined with fertilizer at a 50% rate and “full” watering. When exposed to drought conditions (“half” watering) and a 100% rate of fertilizer the PS3 formulation soil additive performed significantly better than the other three soil additive combinations. Based on these results PS3 is considered a relatively “robust” soil additive as compared to soil additive formulations having only two of the three soil additive ingredients (DE, biochar, and gypsum). While not being bound by theory, it is believed that one or more of the properties of the individual soil ingredients helps provide the “robust” properties when all three are combined together and planted with a crop that is exposed to an environmental stress such as drought.

### Example 14

The purpose of this example was to determine what impact, if any, a soil conditioner would have on the incidence of plant-parasitic nematodes on coffee farms.

Eleven coffee farms (F1 to F11) were selected for sampling. Soil was sampled to include both roots and soils from four coffee bushes to which WonderGro (WG) soil additive had been applied for at least 2 seasons. Soils were also sampled under 4 coffee bushes from adjacent plots where soil was not treated with WonderGro (WG) soil additive. The WonderGro (WG) soil additive included 46% by total weight of DE, 28% by total weight of dolomitic limestone, and 26% by total weight of gypsum. The WonderGro (WG) soil additive was applied at a rate of 100 to 250 grams per coffee bush. This rate equates to 25 to 62.5 grams per square meter. The DE was a coarse grade with the following particle size distribution:

| | |
|---|---|
| Particle size | % |

| | | |
|---|---|---|
| >1 | mm | 5.0 |
| >710 | micron | 5.3 |
| >500 | micron | 9.5 |
| >250 | micron | 25.8 |
| >150 | micron | 21.6 |
| >75 | micron | 30.8 |
| <75 | micron | 1.9 |

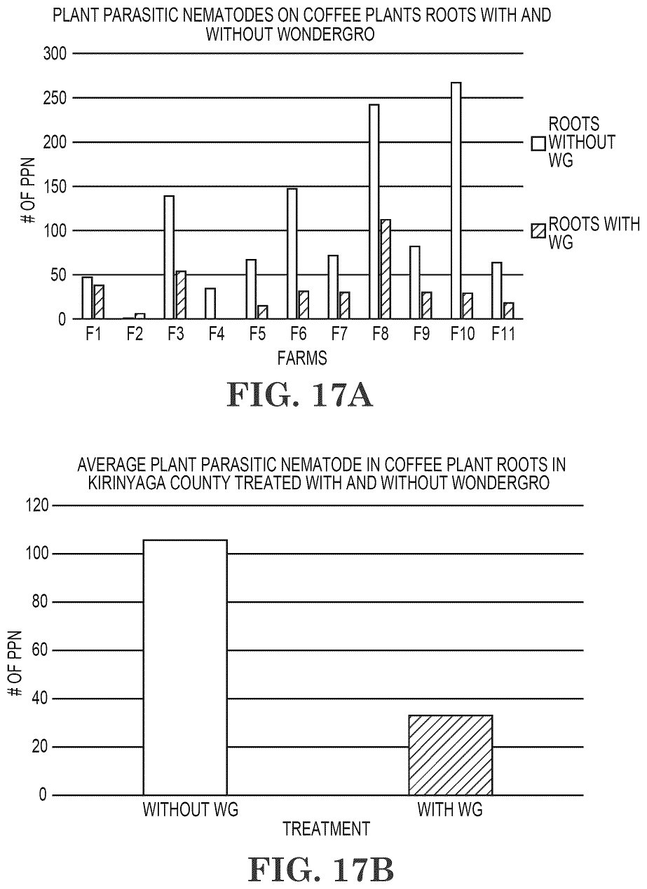

Soils and roots were analyzed for the presence of plant-parasitic nematodes by the International Institute of Tropical Agriculture (IITA), Nairobi, Kenya. The results are shown in FIGS. 17A and 17B, and Table 8 below.

TABLE 8
Free Living Nematodes

| | Plant Parasitic Nematodes (PPN) | | | | Free Living Nematodes (FLN) | | | |
|---|---|---|---|---|---|---|---|---|
| | Roots | | Soil | | Roots | | Soil | |
| | Without | With | Without | With | Without | With | Without | With |
| | WG | WG | WG | WG | WG | WG | WG | WG |
| F1 | 47 | 38 | 71 | 35 | 80 | 96 | 395 | 195 |
| F2 | 1 | 6 | 54 | 50 | 25 | 160 | 421 | 274 |
| F3 | 139 | 54 | 163 | 21 | 88 | 172 | 627 | 635 |
| F4 | 34 | 0 | 313 | 104 | 46 | 54 | 334 | 599 |
| F5 | 67 | 15 | 54 | 302 | 73 | 12 | 362 | 437 |
| F6 | 147 | 31 | 942 | 68 | 101 | 138 | 1264 | 399 |
| F7 | 72 | 30 | 87 | 284 | 26 | 50 | 448 | 769 |
| F8 | 242 | 112 | 311 | 1407 | 33 | 86 | 739 | 601 |
| F9 | 82 | 30 | 59 | 111 | 95 | 43 | 160 | 367 |
| F10 | 267 | 29 | 4 | 60 | 22 | 52 | 423 | 334 |
| F11 | 64 | 18 | 247 | 363 | 3 | 13 | 485 | 443 |
| Mean | 106 | 33 | 210 | 255 | 54 | 80 | 514 | 459 |
| SD | 80.8 | 28.8 | 253.8 | 381.8 | 32.8 | 53.4 | 276.8 | 164.9 |
| SE | 24.38 | 8.68 | 76.52 | 115.12 | 9.89 | 16.10 | 83.47 | 49.73 |

As can be seen, the WonderGro (WG) soil additive had no effect on counts of free-living and plant-parasitic nematodes in the soil. However, the presence of plant-parasitic nematodes in roots on 9 of the 11 farms sampled was reduced about 60% in coffee bushes grown in soil treated with WonderGro (WG) soil additive from 33 to 80 plant-parasitic nematodes per 5 grams of root.

1. A soil additive comprising:
a diatomaceous earth ingredient;
a calcium sulfate ingredient; and
a biochar ingredient.

2. The soil additive of claim 1, wherein the diatomaceous earth ingredient comprises diatomaceous earth ingredient powder, wherein the calcium sulfate ingredient comprises calcium sulfate ingredient powder, wherein the biochar ingredient comprises a biochar ingredient powder.

3. The soil additive of claim 2, wherein the diatomaceous earth ingredient powder has a particle size distribution such that at least 90% by weight of the particles pass through an 18 mesh screen (1000 microns); at least 90% by weight of the particles pass through a 35 mesh screen (500 microns); from 80-95% by weight of the particles pass through a 60 mesh screen (250 microns); from 60-80% by weight of the particles pass through a 140 mesh screen (105 microns); and/or from 50-70% by weight of the particles pass through a 270 mesh screen (53 microns).

4. The soil additive of claim 2, wherein the calcium sulfate ingredient powder has a particle size distribution such that at least 90% by weight of the particles pass through an 18 mesh screen (1000 microns); at least 90% by weight of the particles pass through a 35 mesh screen (500 microns); from 80-95% by weight of the particles pass through a 60 mesh screen (250 microns); from 60-80% by weight of the particles pass through a 140 mesh screen (105 microns); and/or from 50-70% by weight of the particles pass through a 270 mesh screen (53 microns).

5. The soil additive of claim 2, wherein the biochar ingredient powder has a particle size distribution such that at that at least 90% by weight of the particles pass through an 18 mesh screen (1000 microns); at least 90% by weight of the particles pass through a 35 mesh screen (500 microns); from 80-95% by weight of the particles pass through a 60 mesh screen (250 microns); from 60-80% by weight of the particles pass through a 140 mesh screen (105 microns); and/or from 50-70% by weight of the particles pass through a 270 mesh screen (53 microns).

6. The soil additive of claim 2, wherein the diatomaceous earth ingredient is present in the soil additive in an amount from 10-80% dry weight basis (dwb), wherein the calcium sulfate ingredient is present in the soil additive in an amount from 10-80% dwb, and the biochar ingredient is present in the soil additive in an amount from 10-80% dwb.

7. The soil additive of claim 2, wherein the diatomaceous earth ingredient powder is present in the soil additive in an amount from 25-50% dry weight basis (dwb), wherein the calcium sulfate ingredient powder is present in the soil additive in an amount from 25-50% dwb, and the biochar ingredient powder is present in the soil additive in an amount from 25-50% dwb.

8. The soil additive of claim 2, wherein the soil additive consists essentially of the diatomaceous earth ingredient powder, the calcium sulfate ingredient powder, and the biochar ingredient powder.

9. The soil additive of claim 1, wherein the soil additive is a free-flowing powder mixture.

10. The soil additive of claim 2, wherein the soil additive is a plurality of discrete units, wherein each discrete unit comprises a mixture of the diatomaceous earth ingredient powder; the calcium sulfate ingredient powder; and the biochar ingredient powder.

11. (canceled)

12. The soil additive of claim 10, wherein the plurality of discrete units are chosen from granules, pellets, prills, extrusions, and combinations thereof.

13. The soil additive of claim 10, wherein the plurality of discrete units have a moisture content of 20% or less by total weight of the discrete units.

14. The soil additive of claim 10, further comprising one or more binders.

15. (canceled)

16. The soil additive of claim 1, wherein the calcium sulfate ingredient comprises gypsum powder.

17. (canceled)

18. (canceled)

19. A method of making a soil additive, wherein the method comprises mixing at least a diatomaceous earth ingredient; a calcium sulfate ingredient; and a biochar ingredient to form a mixture.

20. (canceled)

21. (canceled)

22. The method of claim 19, further comprising forming the biochar ingredient from one or more crop residues.

23. (canceled)

24. The method of claim 22, wherein one or more crop residues comprise one or more of corn stalks, leaves, husks and cobs.

25. The method of claim 19, wherein mixing further comprises mixing the diatomaceous earth ingredient; the calcium sulfate ingredient; and the biochar ingredient with at one or more additional ingredients to form the mixture, wherein the one or more additional ingredients are chosen from nitrogen fertilizer, perlite, lime, dried distillers' grains, vermiculite, humic acids, beneficial microorganisms, micronutrients, urine, one or more stillage compositions, anaerobic digestion digestate composition, lignin, mushroom phymix, phosphorus-solubilizing bacteria, seaweed residue, organic fertilizer, compost (including Bokashi compost), manure, and combinations thereof.

26.-33. (canceled)

34. A method of using the soil additive of claim 1, wherein the method comprises applying the soil additive to soil.

35.-38. (canceled)

39. A method of growing a plant, wherein the method comprises growing a crop in soil treated with the soil additive of claim 1 and 100 percent or less of synthetic nitrogen fertilizer as compared to a control crop grown with 100 percent of the synthetic nitrogen fertilizer and without the soil additive, wherein the crop produces a yield of 100% or greater of a yield produced by the control crop.

40. A method of remediating biotic stress of a plant caused by one or more organisms,
wherein the method comprises growing a plant in soil treated with the soil additive of claim 1, wherein the plant has a lower biotic stress as compared to a control plant grown in soil without the soil additive.

41.-51. (canceled)
